(19) United States
(12) Patent Application Publication
(10) Pub. No.: US 2004/0139579 A1
(43) Pub. Date: Jul. 22, 2004

(54) Axial rotary hinge assembly

(76) Inventor: Ding-Hone Su, Taipei Hsien (TW)

Correspondence Address: BIRCH STEWART KOLASCH & BIRCH, PO BOX 747, FALLS CHURCH, VA, 22040-0747, US

(21) Appl. No.: 10/348,171

(22) Filed: Jan. 22, 2003

(51) Int. Cl. E05D 11/10

(52) U.S. Cl. 16/351

(57) ABSTRACT

An axial rotary hinge assembly for connecting a main body and a cover to control the elevation, depression, left rotation, and right rotation of the cover comprises an axial base coupled to the main body, a rotary member installed onto the axial base, and a first axial member pivotally coupled to the axial base at the lower section of the rotary member, and a second axial member pivotally coupled to the axial base at the upper section of the rotary member to connect with the cover; by means of controlling the second axial member for the rotation along the axes of elevation or depression, the first axial member provides a left or right axial rotation to the cover; a positioning member of rotary member, a positioning point of the axial base, and a rotary angle of the rotary member restricted by a positioning groove constitute the axial rotary hinge assembly of the present invention.

### FIELD OF INVENTION

The present invention relates to an axial rotary hinge assembly, more particularly to a rotary hinge assembly for connecting the cover of a notebook computer, personal digital assistance, or digital camera.

### BACKGROUND OF THE INVENTION

At present, the way of connecting a display panel of a notebook computer or palm top computer generally adopts the pivotal connection. When such device is in use, the user just needs to open the cover for use; when the device is not in use, the display panel can be folded and connected with the computer system to reduce the volume of the computer and facilitate its storage and transportation.

The prior art hinge assembly can only be elevated or depressed or moved back and forth, so that the notebook user can only operate while facing the display panel. Since the viewing angle of the panel is limited, therefore when other people would like to share the display content, the whole set of notebook computer must be turned to a certain angle for the viewing. Thus, the axial rotary hinge assembly is used in notebook computers. In addition to the function of lifting back and forth, the display panel can also be rotated to face other people very easily, such that other people can share the contents of the display. Such hinge assembly is installed on the electronic device and connected to a cover, so that the cover can have an axial or a radial movement freely. The aforementioned rotary hinge assembly comprises: a main body; a first axial member pivotally coupled to the main body; a rotary member wrapped to the first axial member; a second axial member extended from the rotary member; the second axial member is pivotally coupled to a cover, and such hinge assembly can be rotated to the left or right sides by the first axial member, and can be lifted up and closed back and forth by the second axial member to constitute an axial rotary hinge assembly. Although such hinge assembly can overcome the shortcomings on lifting up back and forth only, such arrangement has the following problems to be resolved. When users want to rotate the hinge to the left or right sides by the first axial member, the cover will touch the key on the keyboard during the rotation, cause damage to the keyboard, or make the rotation not smooth, because the first axial member is pivotally couple to the main body vertically, and the keys on the keyboard of the main body protruded from the panel of the main body. Therefore, when such axial rotary hinge assembly is used, the lower edge of both sides of the cover is cut, so that the lower edge of both ends of the cover is higher than the protrusion of the keyboard. Alternatively, the hinge assembly is heightened to avoid the cover to hit the keyboard during the rotation and cause damages. However, the foregoing solution method is limited by the appearance of the notebook computer and will affect its overall artistic look.

### SUMMARY OF THE INVENTION

The primary objective of the present invention is to overcome the above deficiencies and avoid the existing shortcomings by rotating a first axial member on a rotary member in the left or right directions to lift a cover in order to avoid the cover from hitting the keyboard.

It is a further objective of the present invention to lock the rotary member at a predetermined depression angle to avoid any displacement due to a gentle touch on the keyboard.

To achieve the above objectives, the present invention uses an axial base coupled to a main body and a rotary member installed onto the axial base; the axial base has a positioning section forming a positioning groove and a positioning point. A first axial member is pivotally coupled to the axial base under the rotary member, and the first axial member has an elastic member disposed at the position where the first axial member and the axial base are coupled. The first axial member has a positioning member. A second axial member is pivotally coupled on the rotary member to couple a cover. When the first axial member rotates to the left or right sides, the positioning member will lift the cover to avoid the cover from hitting the keyboard. A positioning member and a positioning point of the axial base are used to restrict the rotary angle of the rotary member, and such arrangement constitutes the axial rotary hinge assembly of the present invention.

### BRIEF DESCRIPTION OF THE DRAWINGS

FIG. 1 is a perspective diagram of the present invention.

FIG. 2 is an illustrative diagram of the disassembled parts of the structure of the present invention.

FIG. 3 is another illustrative diagram of the disassembled parts of the structure of the present invention.

FIGS. 4A, 4B, and 4C are perspective diagrams showing the rotary movement of the present invention.

FIG. 5 is an illustrative diagram of a preferred embodiment of the present invention.

### DETAILED DESCRIPTION OF THE PREFERRED EMBODIMENTS

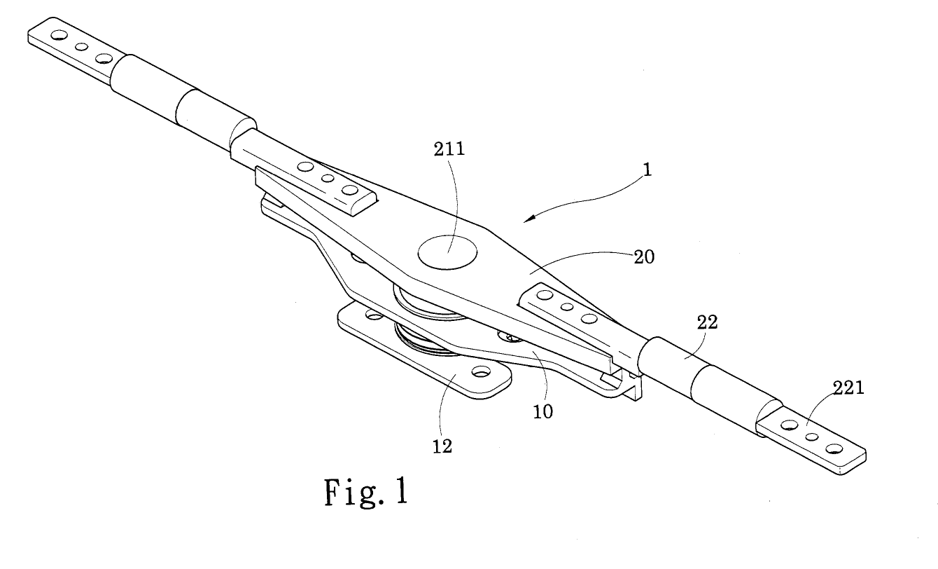

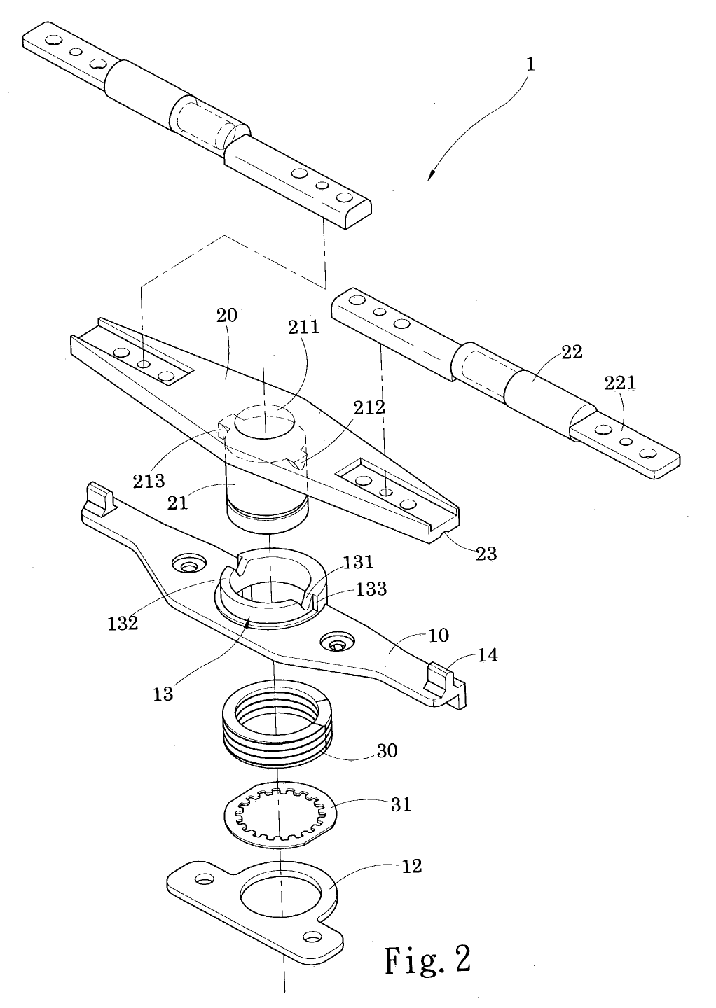

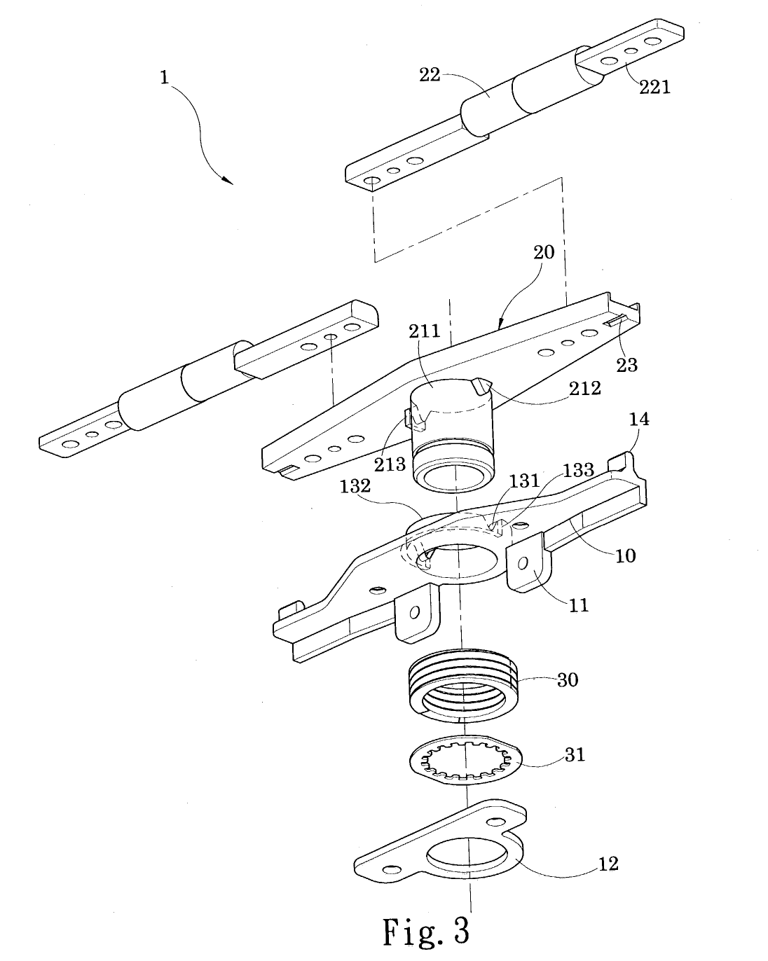

Please refer to FIGS. 1, 2, 3 and 5 for the perspective diagram, disassembled parts of the structure, and illustrative diagrams of a preferred embodiment of the present invention. In the figures, the present invention relates to an axial rotary hinge assembly 1, comprising an axial base 10 coupled to a main body 40; a rotary member 20 installed onto the axial base 10; a coupling section It disposed under the axial base 10, and the axial base 10 has an assisting coupling section 12 under the coupling section 11, so that the axial base 10 and the main body 40 are connected by a multiple of connection points instead of the two-point connection to fix the axial base 10 into a position more securely. A positioning section 13 is disposed on top of the axial base 10, defining a positioning groove 131, a positioning point 132, and a restricting area 133 to control the rotary angle of the rotary member 20. The positioning section 13 at least has two positioning grooves 131, and the maximum angle between the two positioning grooves 131 does not exceed 180 degrees. The positioning point could be a protruded member, so that the axial base 10 and the rotary member 20 have a latch member 14 and a latch groove 23 respectively to assure that the rotary member 20 rotates to a fixed position.

A first axial member 21 disposed under the rotary member 20 is pivotally couple to the axial base 10 to facilitate the assembly of the circuit. The first axial member 21 comprises a through hole 211 in its middle; an elastic member 30 at a position where the first axial member 21 and the axial base 10 are coupled; and a restricting ring 31 under the first axial member 21 and the elastic member 30 to prevent the first axial member and the elastic member 30 from being separated. The first axial member 21 has a positioning member 212 with respect to the positioning groove 131, and a restricting member 213 with respective to the restricting area 133. A second axial member disposed on top of the rotary member 20 is pivotally coupled to a cover 50 and the second axial member 22 is coupled to the rotary member 20 and the cover 50 by the coupling section 221.

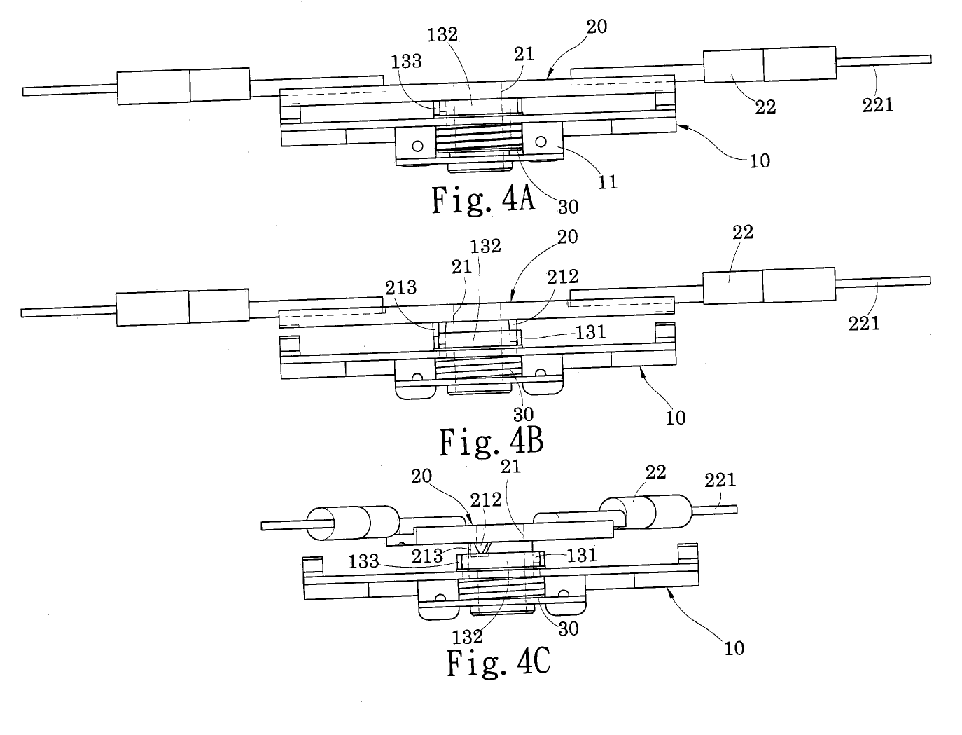

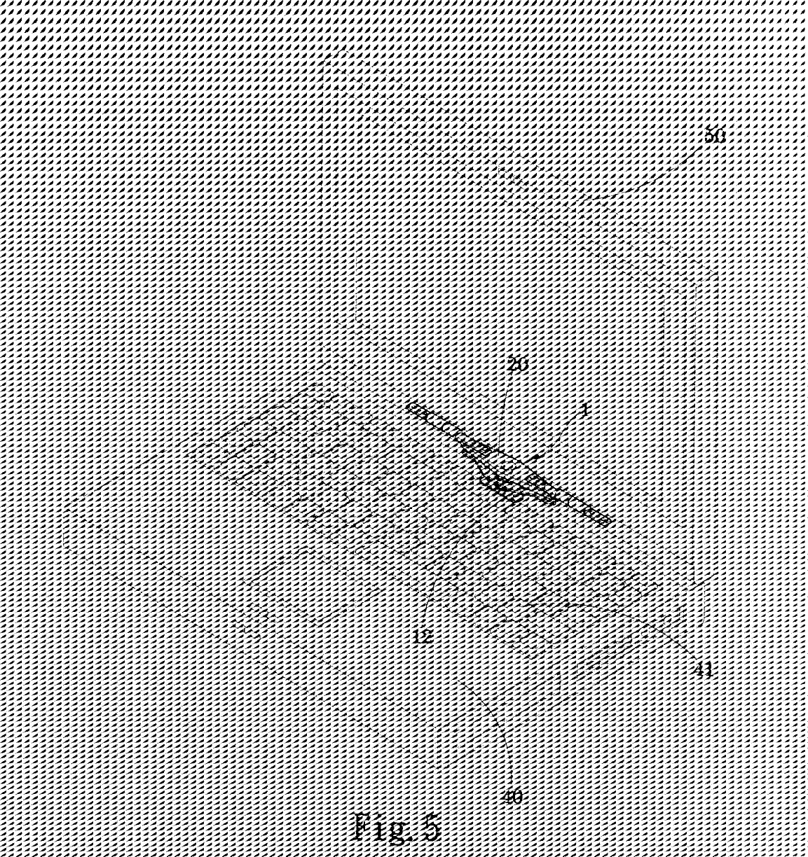

Please refer to FIGS. 4A, 4B, and 4C for the illustrative diagrams of the rotary movement of the present invention. In the figures, an external force is exerted on the rotary member 20, the positioning member 212 originally located in the positioning groove 131 will be shifted upward from the positioning groove 131 to the positioning point 132 because the positioning groove 131 has an inclined angle, and the height of the positioning point 132 is larger than the height of the positioning groove 131. Therefore, the cover 50 (see FIG.5) will be lifted up to the height of the positioning point 132 while the elastic member 30 under the first axial member will be compressed. If the force is applied continuously, the cover 50 will be rotated to the right or left sides, and the lower edge of the cover 50 will not hit or damage the keyboard 41. The positioning section 13 at its other ends has a positioning groove 131. When the rotary member 20 rotates 180 degrees along the left or the right axes, the positioning member 212 will shift downward from another positioning groove 131 and the cover 50 will resume its original height and have a difference of 180 degrees with the original angle. A latch groove 23 under the rotary member 20 and a latch member 14 of the axial base 10 are coupled with each other to assure that the rotary member rotates 180 degrees. Then, the elastic member 30 under the first axial member 21 also resumes its original position and presses against the first axial member 21 such that the rotary member 20 and the cover 50 are maintained in a fixed position while the other side of the positioning groove 131 has a restricting area and when the rotary member 20 rotates to the left or right sides, the restricting member 213 on the first axial member is blocked by the restricting area 133 to avoid the rotary angle of the rotary member 20 exceeding 180 degrees. Since both of the first axial member 21 and the positioning section 13 are metal components, lubricating oil are coated between the first axial member 21 and the positioning section 13 to prevent damage and wearing out by friction.

Two or more positioning grooves are disposed on the positioning section 13 of the axial base 10, so that the positioning member 212 on the first axial member 21 can be used to latch the positioning groove 131 to fix the cover 50 at any predetermined angle, and the rest of the rotary movements are the same as the description above, and thus not described here anymore.

What is claimed is:

1. An axial rotary hinge assembly, for coupling a main body and a cover and controlling the cover to rotate to the left and right sides, comprising:
an axial base, coupled to the main body, having a positioning section which defines a positioning groove and a positioning point;
a rotary member installed onto the axial base, comprising an axial base installed under the rotary member and an elastic member disposed at a position where the first axial member and the axial base being coupled to each other, and the first axial member having a positioning member corresponds to the first axial member; the left and right axial rotations of the cover provided by the first axial member and the rotary angle of the rotary member restricted by the positioning point and the positioning groove of the positioning member and the axial base constituting the axial rotary hinge assembly.

2. The axial rotary hinge assembly of claim 1, wherein said main body is selected from the collection of a notebook computer, a personal digital assistant, and a digital camera, and the cover is a display screen.

3. The axial rotary hinge assembly of claim 1, wherein said axial base has a coupling section for coupling the axial base with the main body.

4. The axial rotary hinge assembly of claim 3, wherein said axial base has an assisting coupling section under the coupling section.

5. The axial rotary hinge assembly of claim 1, wherein said axial base and rotary member respectively have a positioning member and a latch groove.

6. The axial rotary hinge assembly of claim 1, wherein said positioning point is a protruded member.

7. The axial rotary hinge assembly of claim 1, wherein said positioning section at least has two positioning grooves.

8. The axial rotary hinge assembly of claim 1, wherein said positioning groove has a predetermined included angle.

9. The axial rotary hinge assembly of claim 1, wherein said positioning section has a restricting area for controlling the rotary angle of the rotary member.

10. The axial rotary hinge assembly of claim 9, wherein said first axial member has a restricting member corresponds to the restricting area.

11. The axial rotary hinge assembly of claim 1, wherein said first axial member has a restricting ring under the elastic member.

12. The axial rotary hinge assembly of claim 1, wherein said elastic member is selected from a collection of a spring or a substance made of an elastic material.

13. The axial rotary hinge assembly of claim 1, wherein said rotary member has a second axial member pivotally coupled to the upper section of the rotary member for coupling the cover, and the elevation, depression and the radial rotation is controlled by the second axial member.

14. The axial rotary hinge assembly of claim 1, wherein said second axial member has a coupling section for coupling the second axial member with the cover.
